(19) United States
(12) Patent Application Publication
(10) Pub. No.: US 2011/0162721 A1
(43) Pub. Date: Jul. 7, 2011

(54) PROCESS FOR CONVEYING A STREAM OF A LIQUID F COMPRISING (METH)ACRYLIC MONOMERS

(75) Inventors: Steffen Rissel, Kirchheim (DE); Oswin Schmidt, Ellerstadt (DE)

(73) Assignee: BASF SE, Ludwigshafen (DE)

(21) Appl. No.: 12/981,830

(22) Filed: Dec. 30, 2010

Related U.S. Application Data
(60) Provisional application No. 61/292,509, filed on Jan. 6, 2010.

(30) Foreign Application Priority Data
Jan. 6, 2010 (DE) 10 2010 000 706.4

(51) Int. Cl. F17D 1/00

(52) U.S. Cl. 137/2

(57) ABSTRACT

A process for conveying a stream of a liquid F comprising (meth)acrylic monomers with a delivery pump P through a pipeline with circular cross-sectional area OF in which is mounted a restrictor B which firstly closes an area portion of the open cross-sectional area QF and secondly leaves open an area portion TF of the cross-sectional area QF, the outline of which comprises a circular arc of the circular outline of the cross-sectional area QF, said circular arc being within the lower tenth of the circular outline of the cross-sectional area QF.

The present invention relates to a process for conveying a stream of a liquid F comprising (meth)acrylic monomers by means of a delivery pump P through a pipeline whose open cross-sectional area QF pervious to the stream of liquid F is circular and in which is mounted, at a point beyond and/or upstream of the delivery pump P in conveying direction of the stream of liquid F, for the purpose of measurement and/or for the purpose of limiting the flow rate of the stream of liquid F conveyed through the pipeline, a restrictor B which closes an area portion of the open circular cross-sectional area QF there, such that only an open residual area RF of the cross-sectional area QF remains at this point, for the stream of liquid F to flow through.

The notation “(meth)acrylic monomers” in this document is an abbreviated representation of “acrylic monomers and/or methacrylic monomers”. The term “acrylic monomers” in this document is an abbreviated representation of acrylic acid, esters of acrylic acid and/or acrylonitrile. The term “methacrylic monomers” in this document is an abbreviated representation of methacrylic acid, esters of methacrylic acid and/or methacrylonitrile.

The aforementioned esters include esters of acrylic acid and an alcohol having 1 to 12 carbon atoms, and also esters of methacrylic acid and an alcohol having 1 to 12 carbon atoms. Useful alcohols include both monohydric alcohols (have one —OH group) and polyhydric alcohols (have more than one —OH group). These alcohols include especially mono- and polyhydric alcohols having 1 to 12 and preferably 1 to 8 carbon atoms.

This definition does not necessarily include the fact that these esters must be prepared by reaction of the corresponding alcohols with the particular acid. Instead, useful preparation processes are also other reactions, for example transesterifications or addition reactions.

In particular, in this document, the following (meth)acrylic esters shall be encompassed under the term (meth)acrylic monomers: hydroxyethyl acrylate, hydroxyethyl methacrylate, hydroxypropyl acrylate, hydroxypropyl methacrylate, glycidyl acrylate, glycydyl methacrylate, methyl acrylate, methyl methacrylate, n-butyl acrylate, n-butyl methacrylate, tert-butyl acrylate, tert-butyl methacrylate, ethyl acrylate, ethyl methacrylate, 2-ethylhexyl acrylate, 2-ethylhexyl methacrylate, 2-propylheptyl acrylate, N,N-dimethylaminoethyl acrylate and N,N-dimethylaminoethyl methacrylate.

In addition, the term “(meth)acrylic monomers” encompasses the monomers acrolein and methacrolein, which are of significance especially as intermediates (for example for the preparation of acrylic acid and methacrylic acid).

Incidentally, (meth)acrylic monomers (especially those mentioned above) are important starting compounds for preparation of polymers which find use, for example, as adhesives.

### BACKGROUND OF THE INVENTION

(Meth)acrolein and (meth)acrylic acid are prepared on the industrial scale predominantly by heterogeneously catalyzed partial gas phase oxidation of suitable C₃/C₄ precursor compounds, especially of propene and propane in the case of acrolein (one-stage partial oxidation) and acrylic acid (one-stage or two-stage partial oxidation with acrolein as an intermediate), or of isobutene and isobutane in the case of methacrolein (one-stage partial oxidation) and of methacrylic acid (one-stage or two-stage partial oxidation with methacrolein as an intermediate). In addition to propene, propane, isobutene and isobutane, suitable starting materials are, however, also other compounds comprising 3 or 4 carbon atoms, for example isobutanol, n-propanol or the methyl ether of isobutanol.

Normally, a product gas mixture is obtained, from which the (meth)acrolein or the (meth)acrylic acid has to be removed by absorptive, rectificative, extractive and/or crystallizative processes (cf., for example, DE-A 10 224 341). In a corresponding manner, (meth)acrylonitrile is obtainable by catalytic ammoxidation of aforementioned C₃/C₄ precursor compounds and subsequent removal from the product gas mixture.

Esters of (meth)acrylic acid are obtainable, for example, by direct reaction of (meth)acrylic acid with the appropriate alcohols. However, in this case too, product mixtures are initially obtained, from which the (meth)acrylic esters have to be removed, for example, by rectification and/or extraction.

Especially in connection with the aforementioned removals, it is always necessary to convey (meth)acrylic monomers in more or less pure form or in solution (in this document, referred to generally as liquids F comprising (meth)acrylic monomers).

The solvent may either be aqueous or an organic solvent. The specific type of solvent is essentially unimportant in accordance with the invention. It is of course also possible for the (meth)acrylic monomers themselves to be the solvent and for impurities (secondary components) to be the dissolved substances. The content in liquids F to be conveyed (especially solutions) of methacrylic monomers may, for example, be ≧5% by weight, or ≧10% by weight, or ≧20% by weight, or ≧40% by weight, or ≧60% by weight, or ≧80% by weight, or ≧90% by weight, or ≧95% by weight, or ≧99% by weight (especially also in the context of the inventive procedure).

Typically, a liquid F comprising (meth)acrylic monomers is conveyed by means of a delivery pump P (cf., for example, DE-A 10 228 859) as a stream which flows through a pipeline.

The interior of the pipeline normally has a circular open cross-sectional area QF through which the stream of liquid F flows. The term “delivery pump P”, as always in this document, refers to pumps for conveying liquids (i.e. essentially incompressible media). They generally have a suction side and a pressure side. The delivery pump P sucks in the stream of the liquid to be conveyed through a pipeline connected to the suction side. In the delivery pump P, the liquid to be conveyed is subsequently brought to a higher pressure and forced through a pipeline connected to the pressure side thereof in the desired conveying direction. For conveying of liquids F comprising (meth)acrylic monomers, especially the delivery pumps described in DE-A 10 228 859 and DE-A 10 2008 054 587 are suitable (especially the radial centrifugal pumps described in these documents).

Especially in the steady state of a preparation of (meth)acrylic monomers, it is normally of significance that the delivery of a stream of a liquid F comprising (meth)acrylic monomers by means of a delivery pump P through a pipeline proceeds with an essentially constant rate of flow of liquid F over the operating time. Variations in flow rate (which can be caused, for example, by variations of production conditions in the preparation process) can be counteracted, for example, by the ability to variably open or close the access to the suction side or pressure side of the particular delivery pump P by means of suitable valves. In other words, the required delivery flow rate can be established via an adjustment of the opening of the valve. Frequently, the delivery pump P, advantageously in application terms, is, however, a “speed”-controlled delivery pump. In this case, the required delivery flow rate is not established via an adjustment of the free cross section in the valve, but via an adjustment of the speed of the delivery pump. It will be appreciated that both methods of adjusting the flow rate can also be employed in combination.

Before a readjustment of the delivery flow rate can be undertaken, however, a measurement process is required, which determines a deviation in the flow rate of the stream of liquid F conveyed through the pipeline from its target value.

Various measurement processes have been developed for measuring the flow of flowing liquids. A distinction is drawn between processes for measurement of volume flow and mass flow. With knowledge of the mass density of the liquid F being conveyed, the two can be interconverted.

A process which is particularly advantageous in application terms for measuring the volume flow of a liquid F conveyed in a pipeline is what is known as the differential pressure method. In this method, a differential pressure element mounted in the pipeline generates a differential pressure which is detected by an attached instrument (flow meter or differential pressure transducer). The differential pressure element is normally a flow resistor introduced into the pipeline, and the differential pressure is the difference between the pressure existing immediately upstream of the flow resistor in flow direction and that existing immediately beyond the flow resistor in flow direction. The two pressures can be transmitted, for example, through bores in the pipeline and with differential pressure lines connected to the latter to the differential pressure receiver, which may, for example, be a differential pressure manometer which directly displays the differential pressure. The latter is then used to calculate the volume flow via the Bernoulli equation.

Appropriately in application terms, the differential pressure element used is a diaphragm plate. In principle, a diaphragm plate is a metal plate (for example made of stainless steel sheet) with a circular orifice in the middle (cf. FIG. 13). The installation thereof into the pipeline narrows the internal diameter of the pipeline at the installation point from a greater value to a smaller value, thus bringing about restriction of the flow of a stream of a liquid F.

The cross-sectional area pervious to the stream of liquid F is, however, still circular at the point at which the diaphragm plate is mounted in the pipeline, the center of the circle being on the axis on symmetry of the pipeline.

However, diaphragm plates are not only introduced into a pipeline for the purpose of measuring the flow rate of a stream of a liquid F conveyed through a pipeline. Frequently, the installation of a diaphragm plate into a pipeline instead pursues the purpose of limiting the flow rate of a stream conveyed through a pipeline, based on the same delivery pressure. The elevated delivery pressure required to maintain the delivery output thus enables, in the case of a diaphragm plate (or else ring plate) mounted in conveying direction of liquid F in the pipeline, for example, the establishment of an elevated pressure in the conveying zone upstream of the diaphragm plate. The latter allows, for example, a comparatively substantial increase in the temperature of the conveyed liquid F, without the temperature increase being associated with boiling of the conveyed liquid F. Use is made of this basic principle, for example, in the context of use of forced circulation flash evaporators, as detailed by way of example in EP-A 854 129 and in DE-A 102008054587, and also in DE-A 102009027401.

Another objective of a process for preparing (meth)acrylic monomers is typically to be able to operate the process without destruction over a maximum operating time. One cause of occasionally required stoppage to the processes for preparing (meth)acrylic monomers has been found to be occlusions of pipelines in which liquids F comprising (meth)acrylic monomers are conveyed by means of a delivery pump F. This is especially true when a diaphragm plate is mounted in the pipeline for the purpose of measurement and/or for the purpose of limiting the flow rate of the stream of a liquid F comprising (meth)acrylic monomers conveyed through the pipeline.

It was an object of the present invention to at least reduce the above-described disadvantage.

### BRIEF SUMMARY OF THE INVENTION

Accordingly, a process is provided for conveying a stream of a liquid F comprising (meth)acrylic monomers by means of a delivery pump P through a pipeline whose open cross-sectional area QF pervious to the stream of liquid F is circular and in which is mounted, at a point beyond and/or upstream of the delivery pump P in conveying direction of the stream of liquid F, for the purpose of measurement and/or for the purpose of limiting the flow rate of the stream of liquid F conveyed through the pipeline, a restrictor B which closes an area portion of the open circular cross-sectional area QF there, such that only an open residual area RF of the cross-sectional area QF remains (for the stream of liquid F to flow through) at this point, wherein the restrictor B mounted in the pipeline leaves open, as a constituent of the open residual area RF, an area portion TF of the circular cross-sectional area QF, the outline of which comprises a circular arc of the circular outline of the cross-sectional area QF (also referred to in this document as outline U), said circular arc being within the lower tenth of the circular outline of the cross-sectional area QF. The liquid F may be either a solution (optically homogeneous, generally transparent system) or a heterogeneous mixture of different phases (for example gas and liquid phase, but preferably no solid phase). If any two points are fixed on the circumference of a circle and they are connected by the shortest possible circle line running along the circle circumference, this circle line connecting these two points is referred to in this document as a circular arc. The lower tenth of the circular outline of the cross-sectional area QF means the circular arc Z (on which the point TP lies) between the two points P₁ and P₂ on the circle circumference (of the circular outline U) which, with the center M of the circular cross-sectional area QF, form an equilateral triangle in which the corner angle α with the center M as the corresponding corner point is 36°, and the bisector of this corner angle is the straight line g running through the center M and the lowest point of the circular cross-sectional area QF (cf. FIG. 1). Advantageously in accordance with the invention, the outline of the area portion TF comprises at least 5%, or at least 10%, or at least 20%, preferably at least 30%, more preferably at least 40%, advantageously at least 50%, better at least 60% or at least 70%, even better at least 80% or at least 90% and at best 100% of the lower tenth of the circular outline of the cross-sectional area QF.

### BRIEF DESCRIPTION OF THE DRAWINGS

FIG. 1 shows the lowest point of the circular cross-sectional area QF.

FIG. 2 shows the lower half of the circular outline of the cross-sectional area QF and a steel sheet welded across a cross section of a pipeline, where the steel sheet is represented by the dark area.

FIG. 3 shows an embodiment of restrictor B, where the dark area represents a restrictor area and the light area represents open residual area RF.

FIG. 4 shows an embodiment of restrictor B, where the dark area represents a restrictor area and the light area represents open residual area RF.

FIG. 5 shows an embodiment of restrictor B, where the dark area represents a restrictor area and the light area represents open residual area RF.

FIG. 6 shows an embodiment of restrictor B, where the dark area represents a restrictor area and the light area represents open residual area RF.

FIG. 7 shows an embodiment of restrictor B, where the dark area represents a restrictor area and the light area represents open residual area RF.

FIG. 8 shows an embodiment of restrictor B, where the dark area represents a restrictor area and the light area represents open residual area RF.

FIG. 9 shows an embodiment of restrictor B, where the dark area represents a restrictor area and the light area represents open residual area RF.

FIG. 10 shows an embodiment of restrictor B, where the dark area represents a restrictor area and the light area represents open residual area RF.

FIG. 11 shows an embodiment of restrictor B, where the dark area represents a restrictor area and the light area represents open residual area RF.

FIG. 12 shows a steel sheet welded across a cross section of a pipeline, where the steel sheet is represented by the dark area.

FIG. 13 shows a diaphragm plate with a circular orifice in the middle.

### DETAILED DESCRIPTION OF THE INVENTION

Particularly advantageously, the outline of the area portion TF comprises a circular arc of the circular outline of the cross-sectional area QF on which the (geometrically) lowest point TP of the circular outline of the cross-sectional area QF lies.

Processes according to the invention are accordingly especially those processes for conveying a stream of a liquid F comprising (meth)acrylic monomers by means of a delivery pump P through a pipeline whose open cross-sectional area QF pervious to the stream of liquid F is circular and in which is mounted, at a point beyond and/or upstream of the delivery pump P in conveying direction of the stream of liquid F, for the purpose of measurement and/or for the purpose of limiting the flow rate of the stream of liquid F conveyed through the pipeline, a restrictor B which closes an area portion of the open circular cross-sectional area QF there, such that only an open residual area RF of the cross-sectional area QF remains at this point, wherein the restrictor B mounted in the pipeline leaves open, as a constituent of the open residual area RF, an area portion TF of the circular cross-sectional area QF, the outline of which comprises a circular arc of the circular outline of the cross-sectional area QF, said circular arc being within the lower twentieth of the circular outline of the cross-sectional area QF.

The lower twentieth of the circular outline of the cross-sectional area QF means the circular arc Z* (on which the point TP lies) between the two points P₃ and P₄ on the circle circumference (of the circular outline U) which, with the center M of the circular cross-sectional area QF, form an equilateral triangle in which the corner angle α* with the center M as the corresponding corner point is 18°, and the bisector of this corner angle is the straight line g running through the center M and the lowest point of the circular cross-sectional area QF.

The outline of the area portion TF preferably comprises at least 20%, preferably at least 30%, more preferably at least 40%, advantageously at least 50%, better at least 60% or at least 70%, even better at least 80% or at least 90% and at best 100% of the lower twentieth of the circular outline of the cross-sectional area QF.

Particularly advantageously, the outline of the area portion TF here too comprises a circular arc of the circular outline of the cross-sectional area QF on which the (geometrically) lowest point TP of the circular outline of the cross-sectional area QF lies.

In principle, the open residual area RF in the process according to the invention may be at least 10%, or at least 20%, or at least 30%, or at least 40%, or at least 50%, or at least 60%, or at least 70%, or at least 80%, or at least 90% of the cross-sectional area QF. In general, the open residual area RF in the process according to the invention will, however, be ≦90%, frequently ≦80%, in many cases ≦70%, often ≦60% and in some cases ≦50% of the cross-sectional area QF. As always in this document, the cross-sectional area QF means the circular cross-sectional area at that point in the pipeline at which the restrictor B is mounted.

In addition, the area portion TF in the process according to the invention may be identical to the open residual area RF. Of course, the area portion TF in the process according to the invention may, however, also extend only over part (e.g. 5 to 95%, or 10 to 90%, or 20 to 80%, or 30 to 70%, or 40 to 60%) of the residual area RF.

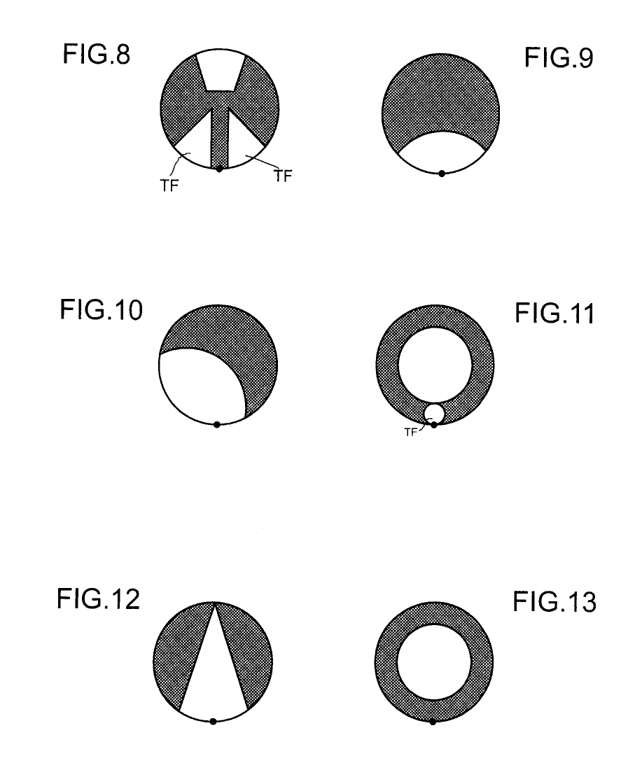

Different embodiments of restrictors B which are suitable in accordance with the invention and have been introduced into the pipeline are shown by FIGS. 2 to 12. The dark area shows the top view (front view) onto the restrictor B. The light area shows the top view onto the open residual area RF and (as at least an area portion thereof) the particular open area portion TF. In addition, each of the figures shows the lowest point TP.

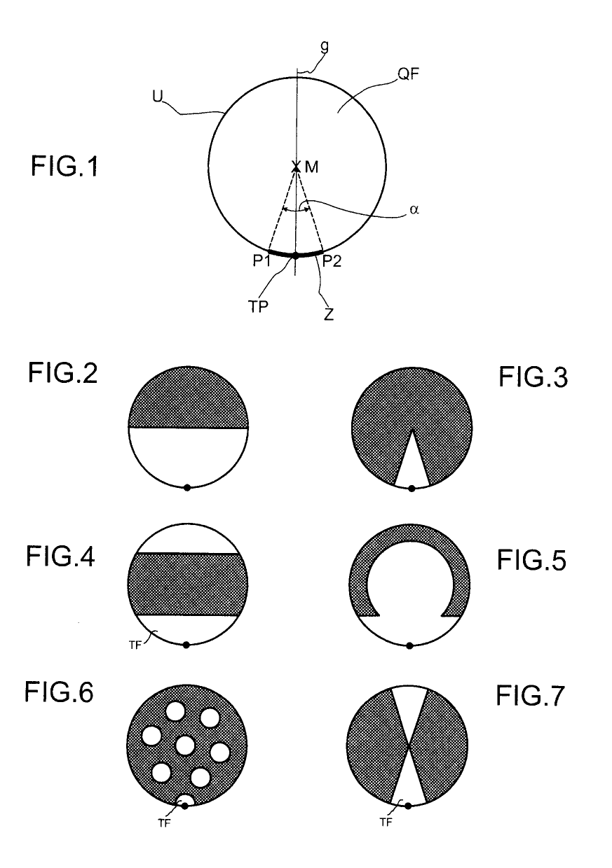

FIG. 1 shows, in a schematic diagram, the circular cross-sectional area QF, the corresponding outline U thereof, the points P₁ and P₂ on the circle circumference, the center M of the circular cross-sectional area QF, the angle α=36°, the lowest point TP of the circular outline U of the circular cross-sectional area QF, and the lower tenth Z of the circular outline U of the cross-sectional area QF. FIG. 13 shows a diaphragm plate according to the prior art. The use thereof in the prior art is attributable especially to its high symmetry. Appropriately in application terms, the dark area in FIGS. 2 to 12 is realized in the form of steel sheets (for example stainless steel sheets of DIN type 1.4539 or 1.4571) welded into the cross section of the pipeline. The thickness of the steel sheet is typically 2 to 15 and frequently 5 to 10 mm.

It will be appreciated that the outline of the area portion TF may comprise a circular arc of the circular outline of the cross-sectional area QF which corresponds, for example, to 100% of the lower half of the circular outline of the cross-sectional area QF (cf., for example, FIG. 2).

The pipeline in which a liquid F comprising (meth)acrylic monomers is conveyed in accordance with the invention need not have a uniform pipe cross section over its total length. It may also have sections in which its cross section is not circular. However, it is essential in accordance with the invention that the cross section thereof at that point at which the restrictor B is installed into the pipeline is circular and has the area QF. A restrictor B may, in accordance with the invention, be installed in the pipeline leading to the suction side of the delivery pump P and/or in the pipeline leading away from the pressure side of the delivery pump P.

The internal diameter corresponding to the circular cross-sectional area QF in the pipeline in which a liquid comprising (meth)acrylic monomers is conveyed may be 1 to 100, often 10 to 90 or 20 to 80, or 30 to 70 or 40 to 60 cm. Preferably in accordance with the invention, the delivery pump P used is a centrifugal pump (especially a radial centrifugal pump), as recommended by DE-A 10228859 and DE-A 102008054587.

The process according to the invention is suitable in the case of all liquids F which comprise at least one (meth)acrylic monomer specified in this document.

Normally, a liquid F conveyed in accordance with the invention comprises added free-radical polymerization inhibitors which counteract an undesired free-radical polymerization of the (meth)acrylic monomers present in the liquid F. Such an undesired free-radical polymerization can proceed, for example, through temperature, light or other spontaneously induced free radical formation. Polymerization inhibitors used with preference for liquids F to be conveyed in accordance with the invention are, for example, p-methoxyphenol (MEHQ), phenothiazine (PTZ), hydroquinone, phenol (e.g. 2,4-dimethyl-6,6-butylphenol), quinones, butylcatechol, diphenylamine, p-phenylenediamines, nitroxyl radicals (e.g. 4-hydroxy-2,2,6,6-tetramethylpiperidine 1-oxyl (4-OH-TEMPO)) and/or nitro compounds, for example nitrophenols (and all other polymerization inhibitors specified in WO 00/64947). Typical polymerization inhibitor contents of liquids F to be conveyed in accordance with the invention are 50 to 2000 ppm by weight, frequently 100 to 1000 ppm by weight, based in each case on the weight of liquid F.

The reason for the advantage of the inventive procedure over use of diaphragm plates B is probably attributable to the fact that liquids F which comprise (meth)acrylic monomers and are to be conveyed in accordance with the invention, even in the presence of polymerization inhibitors dissolved therein, comprise small amounts of dissolved undesired free-radical polymer and/or oligomer of the (meth)acrylic monomers. The word “dissolved” means both “molecularly dissolved” and “colloidally dissolved”. However, both apply only to the extent that the dissolved form in the liquid to be conveyed is visually imperceptible (i.e. to the naked human eye).

When a liquid (e.g. solution) F comprising (meth)acrylic monomers is conveyed through the open residual area of the cross-sectional area QF which remains in the case of incorporation of a diaphragm plate, this then results in creaming of the unwanted polymer and/or oligomer of the (meth)acrylic monomers, which is present molecularly and/or colloidally dissolved in the liquid F. This is attributable to the fact that the ring surrounding the hole orifice of the diaphragm plate in the restrictor is impervious to the liquid F. The polymer and/or oligomer thus accumulates over the course of time in the liquid F present in the vicinity upstream of the diaphragm plate in flow direction (“cream” of liquid F comprising enriched polymer and/or oligomer forms). However, it is known from in-house studies that especially oligomer or polymer present dissolved in liquids F (in contrast to macroscopically visible polymer) exerts a marked polymerization-promoting effect on (meth)acrylic monomers (especially in the case of acrylic acid). This is true in particular in the case of relative molecular weights based on atomic hydrogen of ≧1000, or ≧2000, or ≧3000, of the dissolved polymer and/or oligomer. Over the course of the operating time, there is thus increased probability of occlusion of the hole orifice of the diaphragm plate, which necessitates a process stoppage. In general, such an occlusion, however, also develops rapidly.

In the case of an inventive procedure, in contrast, in parallel to the cream formation at the area portion closed by the restrictor B in the cross-sectional area QF, there is continuous decreaming owing to cream flowing away through the open area portion TF. With the same size of the residual area RF, this results in a reduced tendency to occlusion.

As already mentioned, the inventive procedure is of significance not only in connection with the determination (measurement) of the flow rate of a stream of a liquid F comprising (meth)acrylic monomers conveyed through a pipeline.

Instead, the inventive procedure is in particular also of significance as an element of a supply of thermal energy into a liquid F comprising (meth)acrylic monomers, which is implemented by conveying the liquid F through a forced circulation flash apparatus (cf. EP-A 854129) which is restricted by means of a restrictor B.

The present invention therefore more particularly also comprises a process for continuously thermally separating at least one stream of a mixture G comprising (meth)acrylic monomers in a thermal separating apparatus which comprises
a delivery pump P which has a suction side and a pressure side,
an indirect circulation heat exchanger UW which comprises a secondary space S and a primary space PR which is separated from the secondary space S by a material dividing wall T and has an inlet E and an outlet A,
a separating space R which has a feed point ZU and a return point RT and has or does not have separating internals, into which the stream of the mixture G is conducted continuously at the feed point ZU,
a first delivery connection F1 which leads from the separating space R to the suction side of the delivery pump P,
a second delivery connection F2 which leads from the pressure side of the delivery pump P to the inlet E into the primary space PR of the circulation heat exchanger UW,
a third delivery connection F3 which leads from the outlet A from the primary space PR of the circulation heat exchanger UW to the return point RT into the separating space R, and has a pipeline RL with an open circular cross-sectional area QF, and
a restrictor B which is mounted in the pipeline RL of the delivery connection F3 at a site between the outlet A from the primary space PR of the circulation heat exchanger UW and the return point R1 into the separating space R, and closes an area portion of the open circular cross-sectional area QF of the pipeline RL there, such that only an open residual area RF of the cross-sectional area QF remains at this point in the pipeline RL of the delivery connection F3,
   and in which at least a portion of the energy required for the thermal separation of the mixture G in the separating space R is introduced into the latter by virtue of
the delivery pump P continuously sucking a liquid stream ST which has the temperature T^{SI} and comprises (meth)acrylic monomers out of the separating space R,
the delivery pump P pumping the stream ST that it has sucked in through the delivery connection F2, the primary space PR of the circulation heat exchanger UW and the delivery connection F3 back into the separating space R at the return point RT, and
at the same time, a fluid heat carrier WT whose temperature T^{WT} with which it is conducted into the secondary space S is greater than the temperature T^{SE}, of the stream ST at the inlet E into the primary space PR being conducted through the secondary space S such that the stream ST flows out of the outlet A of the primary space PR of the circulation heat exchanger UW in liquid form toward the residual area RF and flows through the residual area RF with the temperature T^{SII}>T^{SI},
   wherein the restrictor B installed in the pipeline RL of the delivery connection F3, as a constituent of the open residual area RF, leaves open an area portion TF of the circular cross-sectional area QF whose outline comprises a circular arc of the circular outline of the cross-sectional area QF, said circular arc being within the lower tenth of the circular outline of the cross-sectional area QF.

Advantageously in accordance with the invention, here too, the outline of the area portion TF comprises at least 20%, preferably at least 30%, more preferably at least 40%, advantageously at least 50%, better at least 60%, or at least 70%, even better at least 80%, or at least 90% and at best 100% of the lower tenth of the circular outline of the cross-sectional area QF.

Particularly advantageously, the outline of the area portion TF here too comprises a circular arc of the circular outline of the cross-sectional area QF, on which the (geometrically) lowest point TP of the circular outline lies.

Processes according to the invention for continuous thermal separation of at least one stream of a mixture G comprising (meth)acrylic monomers in a thermal separating apparatus of the type described above are therefore especially those wherein the restrictor installed in the pipeline of the delivery connection F3, as a constituent of the open residual area RF, leaves open an area portion TF of the circular cross-sectional area QF, the outline of which comprises a circular arc of the circular outline of the cross-sectional area QF, said circular arc being within the lower twentieth of the circular outline of the cross-sectional area QF.

Advantageously in accordance with the invention, in this case too, the outline of the area portion TF comprises at least 20%, preferably at least 30%, more preferably at least 40%, advantageously at least 50%, better at least 60%, or at least 70%, even better at least 80%, or at least 90% and at best 100% of the lower twentieth of the circular outline of the cross-sectional area QF.

Particularly advantageously, the outline of the area portion TF here too comprises a circular arc of the circular outline of the cross-sectional area QF, on which the (geometrically) lowest point TP of the circular outline of the cross-sectional area QF lies.

Incidentally, all statements made for the process according to the invention for conveying a stream of a liquid F comprising (meth)acrylic monomers by means of a delivery pump P through a pipeline equipped with a restrictor B with the cross-sectional area QF apply correspondingly.

Normally, the separating space R has, in addition to the feed point ZU and the return point RT, also at least one outlet AU1, out of which a stream 1 comprising enriched (meth)acrylic monomers is conducted, and at least one outlet AU2, out of which a stream 2 comprising depleted (meth)acrylic monomers is conducted.

The delivery connections F1, F2 and F3 may in the simplest case each independently be a pipeline. In principle, such a delivery connection may, however, also consist of a combination of pipelines or else of a connection of pipelines to hoses or delivery shafts with, for example, a rectangular cross section.

In principle, the mixture G in the relevant processes for thermal separation can be conducted into the separating space R in gaseous form at the feed point ZU. In general, the mixture G is, however, conducted into the separating space R in liquid form at the feed point ZU. Frequently, this feed is, however, also effected as a mixture of gaseous and liquid phase. It is characteristic of the relevant processes for thermal separation that the separating action achieved with them requires the supply of thermal energy. The achievement of the thermal separating action itself can in principle be achieved in separating spaces which do not comprise any separating internals, as is the case, for example, with a simple distillation (for example an empty column). In this case, a liquid mixture is partially evaporated and the vapor phase obtained, which has a different composition than the liquid mixture, is removed in vaporous and/or condensed form. Frequently, the thermal separating action is, however, achieved with additional action of separating internals, in which case generally gaseous (usually ascending) and liquid (usually descending) streams are conducted in cocurrent or countercurrent in the separating space (for example a separating column comprising internals). Owing to the inequilibrium existing between the streams, heat and mass transfer take place, which ultimately causes the desired separation. In general, the separating internals are present in a separating column as the separating space R. Rectifications in particular are thus thermal separations relevant in accordance with the invention for at least one stream of a mixture G comprising (meth)acrylic monomers. Useful separating internals include, for example, trays (e.g. dual-flow trays, bubble-cap trays, valve trays), structured packings and random packings. The specific procedure may be as described in DE-A 10332758.

The restrictor B installed into the pipeline of the delivery connection F3 in the process according to the invention for thermal separation forms the basis of the establishment, between the pressure side of the delivery pump P and the outlet A of the primary space PR of the circulation heat exchanger UW, of a pressure level which is above that which exists at the return point RT in the separating space R. The temperature T^{SII} can be selected such that the stream ST having this temperature leaves the circulation heat exchanger UW at its outlet A from the primary space PR in the liquid state (i.e. not boiling), flows toward the restrictor B in the liquid state and, only beyond the restrictor B in flow direction, owing to the lower pressure level which exists there, is converted to the boiling state while emerging into the separating space R at the return point RT. The circulation heat exchanger UW used in the process according to the invention for thermal separation is preferably a tube bundle heat transferer (this may have a single-flow or multiflow configuration). The stream ST is preferably conducted through the heat transferer tubes (in which case the total internal volume of all transferer tubes forms the primary space PR), and the fluid heat carrier WT through the secondary space S surrounding the heat transferer tubes. The fluid heat carrier WT used is preferably water vapor at an elevated temperature. Instead of tube bundle heat transferers, it is, however, also possible to use thermoplate heat transferers. Otherwise, the procedure may be as described in EP-A 854129, DE-A 10332758, DE-A 102008001435 and DE-A 102008054587.

Typical flow rates in the process according to the invention for conveying a stream of a liquid F comprising (meth)acrylic monomers by means of a delivery pump P through a pipeline are 100 to 500 000 l/h. Customary temperatures of liquids F conveyed in accordance with the invention are 50 to 160° C. The delivery pressure may be either below or above standard pressure. In general, the delivery pressure is above standard pressure (>1 atm).

The profile of the pipeline having the installed restrictor B in the process according to the invention may either be horizontal or inclined upward or downward proceeding from the delivery pump P. A downwardly inclined or horizontal profile is advantageous in accordance with the invention. Appropriately in application terms, in a process according to the invention for continuous thermal separation of at least one stream of a mixture G comprising (meth)acrylic monomers, the procedure in a thermal separating apparatus is as follows. Proceeding from the outlet A from the primary space PR of the circulation heat exchanger UW, the delivery connection F3 at first runs obliquely from the bottom upward. The pipeline having the installed restrictor B is subsequently configured with a horizontal profile as an element of the delivery connection F3 at the elevated level attained. The return of the delivery connection F3 into the separating space R proceeds thereafter from this elevated level with a downward incline. If the delivery pump P fails, given the aforementioned profile of the delivery connection F3, there is essentially complete emptying of the delivery connection F3 operated in accordance with the invention, which is advantageous in the case of the liquid F which comprises (meth)acrylic monomers and is conveyed therein, owing to the marked tendency thereof to undesired free-radical polymerization.

The difference between T^{SII} and T^{SI} in an inventive thermal separating process may be up to 30° C. or more. It will frequently be 1 to 20° C., or 2 to 15° C., or 3 to 12° C.

The present invention thus comprises especially the following embodiments:
1. A process for conveying a stream of a liquid F comprising (meth)acrylic monomers by means of a delivery pump P through a pipeline whose open cross-sectional area QF pervious to the stream of liquid F is circular and in which is mounted, at a point beyond and/or upstream of the delivery pump P in conveying direction of the stream of liquid F, for the purpose of measurement and/or for the purpose of limiting the flow rate of the stream of liquid F conveyed through the pipeline, a restrictor B which closes an area portion of the open circular cross-sectional area QF there, such that only an open residual area RF of the cross-sectional area QF remains at this point (for the stream of liquid F to flow through), wherein the restrictor B mounted in the pipeline leaves open, as a constituent of the open residual area RF, an area portion TF of the circular cross-sectional area QF, the outline of which comprises a circular arc of the circular outline of the cross-sectional area QF, said circular arc being within the lower tenth of the circular outline of the cross-sectional area QF.
2. The process according to embodiment 1, wherein the outline of the area portion TF comprises at least 10% of the lower tenth of the circular outline of the cross-sectional area QF.
3. The process according to embodiment 1, wherein the outline of the area portion TF comprises at least 30% of the lower tenth of the circular outline of the cross-sectional area QF.
4. The process according to embodiment 1, wherein the outline of the area portion TF comprises at least 40% of the lower tenth of the circular outline of the cross-sectional area QF.
5. The process according to embodiment 1, wherein the outline of the area portion TF comprises at least 60% of the lower tenth of the circular outline of the cross-sectional area QF.
6. The process according to embodiment 1, wherein the outline of the area portion TF comprises at least 80% of the lower tenth of the circular outline of the cross-sectional area QF.
7. The process according to embodiment 1, wherein the outline of the area portion TF comprises all of the lower tenth of the circular outline of the cross-sectional area QF.
8. The process according to embodiment 1, wherein the outline of the area portion TF comprises a circular arc of the circular outline of the cross-sectional area QF, said circular arc being within the lower twentieth of the circular outline of the cross-sectional area QF.
9. The process according to embodiment 8, wherein the outline of the area portion TF comprises at least 10% of the lower twentieth of the circular outline of the cross-sectional area QF.
10. The process according to embodiment 8, wherein the outline of the area portion TF comprises at least 30% of the lower twentieth of the circular outline of the cross-sectional area QF.
11. The process according to embodiment 8, wherein the outline of the area portion TF comprises at least 50% or at least 70% of the lower twentieth of the circular outline of the cross-sectional area QF.
12. The process according to embodiment 8, wherein the outline of the area portion TF comprises all of the lower twentieth of the circular outline of the cross-sectional area QF.
13. The process according to any of embodiments 1 to 12, wherein the outline of the area portion TF comprises a circular arc of the circular outline of the cross-sectional area QF on which the lowest point TP in the circular outline of the cross-sectional area QF lies.
14. The process according to any of embodiments 1 to 13, wherein the open residual area RF is 10 to 90% of the cross-sectional area QF.
15. The process according to any of embodiments 1 to 13, wherein the open residual area RF is 20 to 80% of the cross-sectional area QF.
16. The process according to any of embodiments 1 to 13, wherein the open residual area RF is 30 to 70% of the cross-sectional area QF.
17. The process according to any of embodiments 1 to 16, wherein the area portion TF is 5 to 95% of the open residual area RF.
18. The process according to any of embodiments 1 to 16, wherein the area portion TF is 20 to 80% of the open residual area RF.
19. The process according to any of embodiments 1 to 16, wherein the area portion TF is 30 to 70% of the open residual area RF.
20. The process according to any of embodiments 1 to 16, wherein the area portion TF is identical to the open residual area RF.
21. The process according to any of embodiments 1 to 20, wherein the liquid F comprises at least one (meth)acrylic monomer from the group consisting of acrolein, methacrolein, acrylic acid, methacrylic acid, hydroxyethyl acrylate, hydroxyethyl methacrylate, hydroxypropyl acrylate, hydroxypropyl methacrylate, glycidyl acrylate, glycidyl methacrylate, methyl acrylate, methyl methacrylate, n-butyl acrylate, n-butyl methacrylate, tert-butyl acrylate, tert-butyl methacrylate, ethyl acrylate, ethyl methacrylate, 2-ethylhexyl acrylate, 2-ethylhexyl methacrylate, 2-propylheptyl acrylate, N,N-diethylaminoethyl acrylate and N,N-dimethylaminoethyl methacrylate.
22. The process according to any of embodiments 1 to 20, wherein the liquid F comprises at least one of the monomers acrolein, methacrolein, acrylic acid, methacrylic acid, ester of acrylic acid and an alcohol having 1 to 12 carbon atoms, and ester of methacrylic acid and an alcohol having 1 to 12 carbon atoms.
23. The process according to any of embodiments 1 to 22, wherein the content in the liquid F of (meth)acrylic monomers is ≧5% by weight.
24. The process according to any of embodiments 1 to 22, wherein the content in the liquid F of (meth)acrylic monomers is ≧20% by weight.
25. The process according to any of embodiments 1 to 22, wherein the content in the liquid F of (meth)acrylic monomers is ≧40% by weight.
26. The process according to any of embodiments 1 to 22, wherein the content in the liquid F of (meth)acrylic monomers is ≧60% by weight.
27. The process according to any of embodiments 1 to 22, wherein the content in the liquid F of (meth)acrylic monomers is ≧80% by weight.
28. The process according to any of embodiments 1 to 27, wherein the liquid F is a solution.
29. The process according to any of embodiments 1 to 28, wherein the temperature of the liquid F is 50 to 160° C.
30. The process according to any of embodiments 1 to 29, wherein the diameter corresponding to the circular cross-sectional area QF is 1 to 100 cm, or 10 to 90 cm, or to 70 cm.
31. The process according to any of embodiments 1 to 30, wherein the flow rate of liquid F conveyed through the pipeline is 100 to 500 000 l/h.
32. The process according to any of embodiments 1 to 31, wherein the pressure in the conveyed liquid F is above 1 atm.
33. A process for continuously thermally separating at least one stream of a mixture G comprising (meth)acrylic monomers in a thermal separating apparatus which comprises
   a delivery pump P which has a suction side and a pressure side,
   an indirect circulation heat exchanger UW which comprises a secondary space S and a primary space PR which is separated from the secondary space S by a material dividing wall T and has an inlet E and an outlet A,
   a separating space R which has a feed point ZU and a return point RT and has or does not have separating internals, into which the stream of the mixture G is conducted continuously at the feed point ZU,
   a first delivery connection F1 which leads from the separating space R to the suction side of the delivery pump P,
   a second delivery connection F2 which leads from the pressure side of the delivery pump P to the inlet E into the primary space PR of the circulation heat exchanger UW,
   a third delivery connection F3 which leads from the outlet A from the primary space PR of the circulation heat exchanger UW to the return point RT into the separating space R, and has a pipeline RL with an open circular cross-sectional area QF, and
   a restrictor B which is mounted in the pipeline RL of the delivery connection F3 at a site between the outlet A from the primary space PR of the circulation heat exchanger UW and the return point RT into the separating space R, and closes an area portion of the open circular cross-sectional area QF of the pipeline RL there, such that only an open residual area RF of the cross-sectional area QF remains at this point in the pipeline RL of the delivery connection F3,
      and in which at least a portion of the energy required for the thermal separation of the mixture G in the separating space R is introduced into the latter by virtue of
   the delivery pump P continuously sucking a liquid stream ST which has the temperature T^{SI} and comprises (meth)acrylic monomers out of the separating space R,
   the delivery pump P pumping the stream ST that it has sucked in through the delivery connection F2, the primary space PR of the circulation heat exchanger UW and the delivery connection F3 back into the separating space R at the return point RT, and
   at the same time, a fluid heat carrier WT whose temperature T^{WT} with which it is conducted into the secondary space S is greater than the temperature T^{SE} of the stream ST at the inlet E into the primary space PR being conducted through the secondary space S such that the stream ST flows out of the outlet A of the primary space PR of the circulation heat exchanger UW in liquid form toward the residual area RF and flows through the residual area RF with the temperature T^{SII}>T^{SI},
      wherein the restrictor B installed in the pipeline RL of the delivery connection F3, as a constituent of the open residual area RF, leaves open an area portion TF of the circular cross-sectional area QF whose outline comprises a circular arc of the circular outline of the cross-sectional area QF, said circular arc being within the lower tenth of the circular outline of the cross-sectional area QF.
34. The process according to embodiment 33, wherein the separating space R has at least one outlet AU1 from which a stream 1 comprising enriched (meth)acrylic monomers is discharged, and at least one outlet AU2 from which a stream 2 comprising depleted (meth)acrylic monomers is discharged.
35. The process according to embodiment 33 or 34, wherein the conveying of liquid stream ST through the pipeline RL is a process according to any of embodiments 1 to 32, the liquid stream ST being the stream of the liquid F to be conveyed according to embodiments 1 to 32.

### Example and Comparative Example

Process for continuous thermal separation of a stream of a mixture G comprising acrylic acid in a thermal separating apparatus

The liquid mixture G has the following contents:

4.49% by weight of acrylic acid,
0.0253% by weight of acetic acid,
0.0099% by weight of water,
55.77% by weight of diphyl,
37.85% by weight of dimethyl phthalate,
0.0003% by weight of formic acid,
0.0025% by weight of acrolein,
0.0007% by weight of propionic acid,
0.0023% by weight of furfurals,
0.0001% by weight of allyl acrylate,
0.0291% by weight of benzaldehyde,
0.01374% by weight of maleic anhydride,
0.366% by weight of benzoic acid,
0.966% by weight of diacrylic acid,
0.280% by weight of phenothiazine, and
0.0001% by weight of molecular oxygen.

Its temperature was 152.4° C. It was withdrawn from the bottom region of an absorption column. The absorption process was for the purpose of removing acrylic acid from the product gas mixture of a heterogeneously catalyzed partial gas phase oxidation of propene to acrylic acid, as described in DE-A-10336386.

8902 kg/h of the liquid mixture G were supplied to a thermal separating apparatus which comprised a separating column as the separating space R and a circulation heat exchanger UW, and also a delivery pump P.

The circulation heat exchanger UW was an eight-flow tube bundle heat transferer which comprised 704 heat transferer tubes. The internal diameter of the tubes was a uniform 21 mm, with a wall thickness of 2 mm and a pipe length of 2500 mm. The material of manufacture was DIN material 1.4571. The internal diameter of the circular cylindrical heat transferer was 1100 mm. The heat carrier supplied to the secondary space of the tube bundle heat exchanger surrounding the heat transferer tubes was 1800 kg/h of saturated steam (29 bar, 231° C.). By means of 7 circular deflecting plates (the ratio of free cross section to closed cross section was in each case 3:8), the steam stream was conducted around the transferer tubes in the tube bundle heat transferer. The steam condensate which forms in the heat transferer was conducted out of the heat transferer at a temperature of 200° C.

The delivery pump P which accomplishes the forced circulation was a radial centrifugal pump with a closed impeller from Sulzer of the ZE 200/400 type. The barrier liquid used was a mixture of 50% by weight of glycol and 50% by weight of water.

The separating column had a cylindrical cross section with an internal diameter of 2200 mm. The height of the cylindrical section was 7402 mm.

The material of manufacture was DIN material 1.4571; the wall thickness was 12 mm. The internal diameter of the upper exit stub was 900 mm; the diameter of the lower exit stub was 400 mm. The separating column had no separating internals. The upper exit stub was conducted into the separating column to a length of 558 mm. Around this stub conducted into the column was additionally mounted, projecting from the upper end of the separating column downward, an annular collar whose collar length was 500 mm. The top pressure of the separating column was set to 85 mbar. The separating column was operated without return liquid. The separating column was operated under level control. The maximum level of the liquid (still comprising acrylic acid) accumulated at the lower end of the separating column was 1932 mm, and the minimum level was 900 mm. The liquid mixture G was supplied to the separating column cyclically in the appropriate manner. Through the top of the upper exit stub of the separating column, 8642 kg/h of vapor formed in the column was conducted out with a temperature of 180° C.

The contents of this vapor stream were:
4.346% by weight of acrylic acid,
0.0260% by weight of acetic acid,
0.0102% by weight of water,
56.46% by weight of diphyl,
37.279% by weight of dimethyl phthalate,
0.0003% by weight of formic acid,
0.0025% by weight of acrolein,
0.0007% by weight of propionic acid,
0.0024% by weight of furfurals,
0.0001% by weight of allyl acrylate,
0.0299% by weight of benzaldehyde,
0.141% by weight of maleic anhydride,
0.369% by weight of benzoic acid,
1.244% by weight of diacrylic acid,
0.0004% by weight of glyoxal and
0.0001% by weight of molecular oxygen.

The delivery pump P was used to suck in, from the lower exit stub of the separating column, with the temperature T^{SI}=180° C., a liquid stream S (still comprising acrylic acid) of 204 176 kg/h. A substream thereof was discharged and sent to incineration. The remaining liquid residual stream of 203 916 kg/h was pumped through the heat transferer tubes of the circulation heat exchanger UW. The residual stream flowed with a temperature of 189° C. in liquid form out of the heat transferer tubes (the primary space PR of the circulation heat exchanger UW). Through a pipeline which has an open cross-sectional area of 196 250 mm² and an internal volume of 1.8 m³, the liquid residual stream at 189° C. flowed in the direction of the separating column. After about two thirds of the total length of the pipeline, a diaphragm plate was mounted therein. The cross-sectional area of the hole orifice was 49 063 mm². At a height of about 3563 mm (from the bottom), the superheated residual stream (the pressure of which at the outlet from the heat transferer tubes was 4 bar) was recycled into the separating column. At the same height, the mixture G was supplied into the separating column.

After an operating time of 2 months, 3 weeks ands 4 days, the process for thermal separation had to be stopped since the hole orifice of the diaphragm plate was occluded.

When the diaphragm plate was replaced by a restrictor B according to FIG. 3, the open residual area of which was likewise 49 063 mm², no occlusion of the restrictor B had yet formed even after an operating time of 4 months.

U.S. Provisional Patent Application No. 61/292,509, filed Jan. 6, 2010, is incorporated into the present patent application by literature reference. With regard to the above-mentioned teachings, numerous changes and deviations from the present invention are possible. It can therefore be assumed that the invention, within the scope of the appended claims, can be performed differently than the way described specifically herein.

1. A process for conveying a stream of a liquid F comprising (meth)acrylic monomers by means of a delivery pump P through a pipeline whose open cross-sectional area QF pervious to the stream of liquid F is circular and in which is mounted, at a point beyond and/or upstream of the delivery pump P in conveying direction of the stream of liquid F, for the purpose of measurement and/or for the purpose of limiting the flow rate of the stream of liquid F conveyed through the pipeline, a restrictor B which closes an area portion of the open circular cross-sectional area QF there, such that only an open residual area RF of the cross-sectional area QF remains at this point, wherein the restrictor B mounted in the pipeline leaves open, as a constituent of the open residual area RF, an area portion TF of the circular cross-sectional area QF, the outline of which comprises a circular arc of the circular outline of the cross-sectional area QF, said circular arc being within the lower tenth of the circular outline of the cross-sectional area QF.

2. A process for continuously thermally separating at least one stream of a mixture G comprising (meth)acrylic monomers in a thermal separating apparatus which comprises
a delivery pump P which has a suction side and a pressure side,
an indirect circulation heat exchanger UW which comprises a secondary space S and a primary space PR which is separated from the secondary space S by a material dividing wall T and has an inlet E and an outlet A,
a separating space R which has a feed point ZU and a return point RT and has or does not have separating internals, into which the stream of the mixture G is conducted continuously at the feed point ZU,
a first delivery connection F1 which leads from the separating space R to the suction side of the delivery pump P,
a second delivery connection F2 which leads from the pressure side of the delivery pump P to the inlet E into the primary space PR of the circulation heat exchanger UW,
a third delivery connection F3 which leads from the outlet A from the primary space PR of the circulation heat exchanger UW to the return point RT into the separating space R, and has a pipeline RL with an open circular cross-sectional area QF, and
a restrictor B which is mounted in the pipeline RL of the delivery connection F3 at a site between the outlet A from the primary space PR of the circulation heat exchanger UW and the return point RT into the separating space R, and closes an area portion of the open circular cross-sectional area QF of the pipeline RL there, such that only an open residual area RF of the cross-sectional area QF remains at this point in the pipeline RL of the delivery connection F3,
and in which at least a portion of the energy required for the thermal separation of the mixture G in the separating space R is introduced into the latter by virtue of
the delivery pump P continuously sucking a liquid stream ST which has the temperature T^{SI} and comprises (meth)acrylic monomers out of the separating space R,
the delivery pump P pumping the stream ST that it has sucked in through the delivery connection F2, the primary space PR of the circulation heat exchanger UW and the delivery connection F3 back into the separating space R at the return point RT, and
at the same time, a fluid heat carrier WT whose temperature T^{WT} with which it is conducted into the secondary space S is greater than the temperature T^{SE} of the stream ST at the inlet E into the primary space PR being conducted through the secondary space S such that the stream ST flows out of the outlet A of the primary space PR of the circulation heat exchanger UW in liquid form toward the residual area RF and flows through the residual area RF with the temperature T^{SII}>T^{SI},
wherein the restrictor B installed in the pipeline RL of the delivery connection F3, as a constituent of the open residual area RF, leaves open an area portion TF of the circular cross-sectional area QF whose outline comprises a circular arc of the circular outline of the cross-sectional area QF, said circular arc being within the lower tenth of the circular outline of the cross-sectional area QF.
